(19) United States
(12) Patent Application Publication
(10) Pub. No.: US 2025/0080673 A1
(43) Pub. Date: Mar. 6, 2025

(54) INFORMATION TERMINAL, METHOD OF CONTROLLING INFORMATION TERMINAL, AND ELECTRONIC RECEIPT SYSTEM

(71) Applicant: Toshiba Tec Kabushiki Kaisha, Tokyo (JP)

(72) Inventors: Yasuhiro ARAI, Mishima Shizuoka (JP); Mina YAMADA, Adachi Tokyo (JP)

(21) Appl. No.: 18/787,585

(22) Filed: Jul. 29, 2024

(30) Foreign Application Priority Data
Aug. 28, 2023 (JP) 2023-138295

(51) Int. Cl. H04N 1/32; G06Q 20/04

(52) U.S. Cl. CPC H04N 1/32128; G06Q 20/047

(57) ABSTRACT

According to an embodiment, an information processing terminal includes a storage unit and a communication interface to connect to a receipt server storing receipt data in electronic format. A control unit of the terminal is configured to cause a receipt image corresponding to the receipt data received from the receipt server to be displayed on a display device along with an instruction input part for receiving a user selection of an option for storage of data corresponding to the receipt image and create an electronic image file corresponding to the receipt image displayed on the display device. The control unit receives the user selection of the option and causes the electronic image file to be stored in the storage unit or sent via e-mail to a user-designated e-mail address according to the selection.

### CROSS-REFERENCE TO RELATED APPLICATION

This application is based upon and claims the benefit of priority from Japanese Patent Application No. 2023-138295, filed Aug. 28, 2023, the entire contents of which are incorporated herein by reference.

### FIELD

An embodiment of the present disclosure relates to an information terminal, a method of controlling the information terminal, and an electronic receipt system.

### BACKGROUND

For the Japanese domestic tax system, an invoice system related to a new purchase tax credit system enters into effect from Oct. 1, 2023. When the invoice system is introduced, a buyer who is a consumption tax payer can receive the purchase tax credit only when an invoice issued by a seller who is an eligible invoice issuer additionally meets the requirements for eligible invoices.

Generally, in a transaction settlement a store may sell commodities to a large number of unspecified buyers and issue receipts to these buyers. Since normally a receipt including the transaction date, the transaction content (e.g., items purchased), the taxable amount of money subject to consumption tax rate, the amount of tax paid, and so on is printed upon completion of the transaction, may be possible to use the receipt as an eligible invoice for the tax credit if a registry number for the eligible invoice user is also included on the printed receipt.

However, in recent years, systems and services for replacing paper receipts with electronic receipts or the like have been developed. For such systems and services, an information terminal, such as a smartphone, may be used to display an image of the receipt on a display screen or the like. That is, so-called “electronic receipt services,” have been developed and adopted for practical use. A receipt image provided via an electronic receipt service can also be used as an eligible invoice as long as it satisfies the requirements for use in the tax credit system. However, in order to use the receipt image as an eligible invoice, it is generally necessary to convert the receipt image into an image file and then store the image file for subsequent retrieval/use.

### BRIEF DESCRIPTION OF THE DRAWINGS

FIG. 1 is a schematic diagram of an electronic receipt system.

FIG. 2 is a block diagram of a receipt server.

FIG. 3 is a schematic diagram of a receipt record.

FIG. 4 is a schematic diagram of a membership record.

FIG. 5 is a block diagram of an information terminal.

FIG. 6 is a flowchart depicting certain aspects of information processing executed by a processor of an information terminal.

FIG. 7 is a flowchart depicting certain aspects of information processing executed by a processor of an information terminal.

FIG. 8 is a flowchart depicting certain aspects of information processing executed by a processor of an information terminal.

FIG. 9 is a flowchart depicting certain aspects of information processing executed by a processor of an information terminal.

FIG. 10 is a flowchart depicting certain aspects of information processing executed by a processor of an information terminal.

FIG. 11 is a flowchart certain aspects of information processing executed by a processor of a receipt server.

FIG. 12 is a schematic diagram showing an example of an image to be displayed as a home screen.

FIG. 13 is a schematic diagram showing an example of an image to be displayed as a configuration screen.

FIG. 14 is a schematic diagram showing an example of an image to be displayed as a receipt list screen.

FIG. 15 is a schematic diagram showing an example of an image to be displayed as a receipt detail screen.

FIG. 16 is a schematic diagram showing an example of an image to be displayed as a storage type selection screen.

FIG. 17 is a schematic diagram showing an example of an image to be displayed as a preview screen.

FIG. 18 is a schematic diagram showing an example of a pop-up image.

FIG. 19 is a schematic diagram showing an example of an image to be displayed as a preview screen.

FIG. 20 is a schematic diagram showing an example of a pop-up image.

FIG. 21 is a schematic diagram showing an example of an image to be displayed as a condition input screen.

FIG. 22 is a schematic diagram showing an example of a pull-down list by which a receipt type can be selected.

FIG. 23 is a schematic diagram showing an example of an image to be displayed as a narrowed-down receipt list screen.

FIG. 24 is a processing sequence diagram for an information terminal and a receipt server for saving an image file in a storage unit provided to the information terminal.

FIG. 25 is a processing sequence diagram for an information terminal and a receipt server for transmitting an e-mail with an image file to a preset mail address as a destination.

FIG. 26 is a schematic diagram showing an example of issuance of a receipt which can be used as an eligible invoice.

FIG. 27 is a schematic diagram showing an example of issuance of a corrected receipt taking the receipt shown in FIG. 26 as an original receipt.

### DETAILED DESCRIPTION

A problem to be solved by the embodiment of the present disclosure is to provide an information terminal and an electronic receipt system letting a user easily obtain an image file by converting a receipt image displayed on a display device of the terminal into an electronic file.

According one embodiment, an information to processing terminal includes a storage unit, a communication interface, and a control unit. The communication interface is configured to connect to a receipt server storing receipt data in electronic format in association with buyer identification information. The control unit is configured to: cause a receipt image corresponding to the receipt data received from the receipt server to be displayed on a display device along with an instruction input part for receiving a user selection of an option for storage of data corresponding to the receipt image; create an electronic image file corresponding to the receipt image displayed on the display device; receive the user selection of the option for the storage of the data corresponding to the receipt image via the instruction input part; and cause the electronic image file to be stored in the storage unit or sent via e-mail to a user-designated e-mail address.

Certain example embodiments of an information processing terminal, a system incorporating such a terminal, and methods for such terminals and systems will hereinafter be described using the drawings.

### Description of Electronic Receipt System

First, an electronic receipt system which makes it possible to display an image of a receipt on which purchase data as a bill of purchased commodities and so on is recorded on a display device of an information terminal owned by a buyer who purchases the commodities in a store will be described.

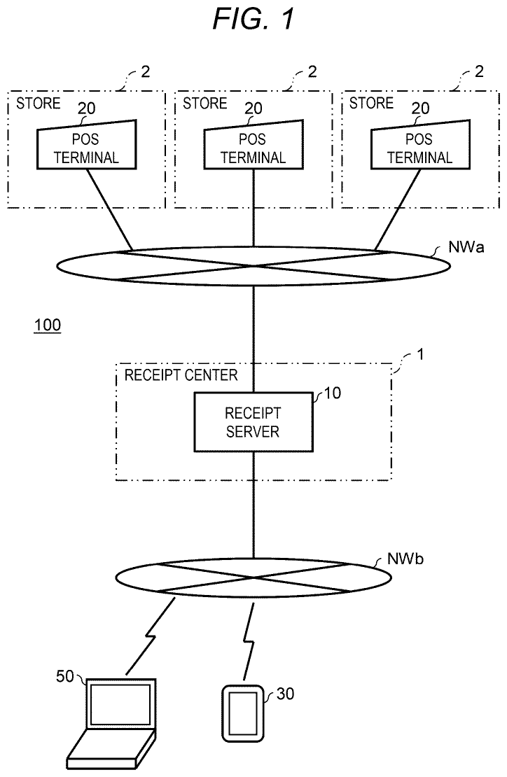

FIG. 1 is a schematic diagram showing a schematic configuration of an electronic receipt system 100. The electronic receipt system 100 includes a receipt server 10, and a plurality of POS (Point Of Sales) terminals 20. The receipt server 10 is provided by a receipt center 1. The receipt center 1 is a computer system which is managed by an operating company of an electronic receipt service. The receipt center 1 may include a server other than the receipt server 10.

The POS terminals 20 are disposed in stores 2. In general, the stores 2 sell commodities to a large number of possibly unknown or unspecified buyers. The stores 2 may be such things as a supermarket, a convenience store, or a retail specialty store. The store 2 may also be a store selling commodities to specified buyers or registered members. A store 2 could be a store which provides a service such as a barbershop, a rental shop, or a bowling alley. It should be noted that although in FIG. 1, it is depicted one POS terminal 20 is installed per store 2, the number of the POS terminals 20 in each store 2 is not particularly limited. That is, two or more POS terminals 20 may be installed in a store 2 in some examples.

The electronic receipt system 100 couples the receipt server 10 and the POS terminals 20 of the respective stores 2 to each other with a first communication network NWa. The first communication network NWa is a network dedicated to the electronic receipt system using, for example, the Internet, an intranet, and a virtual private network (VPN). It should be noted that the POS terminals 20 may be indirectly coupled to the first communication network NWa via a transponder such as a communication server instead of being directly coupled to the first communication network NWa.

The POS terminals 20 are each a settlement device which executes processing of registering items being purchased by a buyer and processing transaction settlement (payments) for the buyer. The POS terminals 20 may be a face-to-face type POS terminal with which a sales clerk takes care of the operations for registration and settlement, or may be a self-service type POS terminal with which a consumer (buyer) himself or herself takes care of registration and settlement operations. Alternatively, the POS terminals 20 may each be a split type POS terminal with which a sales clerk takes care of registration operations and the consumer takes care of settlement operations. For a face-to-face type POS terminal, a self-service type POS terminal, or a split type POS terminal, various known POS terminals may directly be applied. The POS terminals 20 may be referred to as an electronic cash register, a checkout device, a merchandise sale data processing device, a merchandise registration device, or the like.

It should be noted that the settlement device may also be, for example, a settlement device (or an adjustment device) which does not have a registration function for registering merchandise, and which performs the settlement processing based on registration information. The settlement device may also be a system which is constituted by a tablet terminal for inputting or displaying information of merchandise and a server which is coupled to the tablet terminal via a communication network. In this case, the tablet terminal functions as a device for inputting the information about the merchandise and displaying the information about the merchandise. The server functions as a device which receives the information about the merchandise as input by the tablet terminal to perform the registration processing and which executes the settlement processing based on the information thus registered.

The POS terminals 20 each have an electronic receipt function for digitizing a receipt (or otherwise generating an electronic receipt) to be issued to a buyer when the buyer is a registered electronic receipt member of the operating company of the electronic receipt service. The electronic receipt function becomes available by executing, for example, a customized agent program. The agent program is application software for generating electronic receipt data based on print data of a receipt. Specifically, the agent program analyzes the print data of the receipt to thereby extract information to be included in the electronic receipt data, and to determine item or category names for the extracted information. Such item or category names may be based on the position of the information in the receipt and the like. Then, the agent program generates, as receipt data, data which represents correspondences between the extracted information and the item or category names determined for that information. The receipt data thus generated is transmitted to the receipt server 10 via the first communication network NWa.

The receipt server 10 is a computer device which performs a service making it possible to display an image of the receipt issued by the stores 2 using the information terminal 30 owned by the buyer who is the electronic receipt member. The receipt server 10 may provide the service in an on-premise environment or in a cloud computing environment.

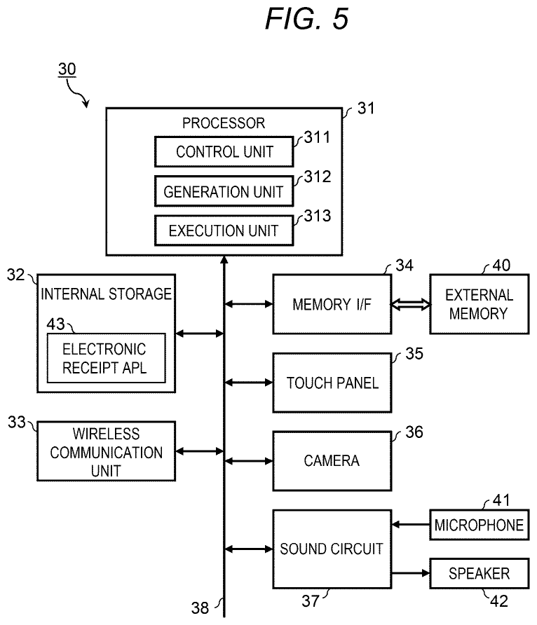

The information terminal 30 is a portable communication terminal such as a smartphone or a tablet. Customized application software for the electronic receipt service, such as an electronic receipt app 43 (see FIG. 5), is installed in the information terminal 30. The owner of the information terminal 30 may first perform membership registration with the operating company of the electronic receipt service by using the electronic receipt app 43 if not already a member. By making the membership registration, unique identification information, namely an electronic receipt ID, is assigned by the operating company. The electronic receipt ID can be set for the particular information terminal 30. Further, when starting up the electronic receipt app 43 the electronic receipt ID may be displayed on a top screen in the form of a machine-readable code such as a barcode or a two-dimensional code. When the electronic receipt member purchases something at a store 2 as a buyer, it is possible to receive a receipt as an electronic receipt by causing the POS terminal 20 to read the electronic receipt ID from the information terminal 30 or the like.

The receipt server 10 receives and then stores the receipt data generated by the POS terminal 20. Then, when an inquiry about the electronic receipt is made by the information terminal 30 owned by an electronic receipt member via a second communication network NWb, the receipt server 10 extracts the receipt data which was previously generated by the POS terminal 20. The receipt server 10 transmits data of a receipt image based on the receipt data thus extracted to the information terminal 30 via the second communication network NWb. In this way, the receipt can be displayed as an image on the display device of the information terminal 30.

As described above, the second communication network NWb is a wide area network capable of performing data transfer between the receipt server 10 and the information terminals 30 owned by the respective electronic receipt members. A computer device 50 which is capable of receiving e-mails transmitted via the second communication network NWb can be coupled to the second communication network NWb. The computer device 50 is, for example, a personal computer. The computer device 50 may be, for example, a cloud storage server. As described above, as the second communication network NWb the Internet, a mobile communication network, and/or a public telecommunication network can be use alone or in combination as appropriate.

### Description of Receipt Server

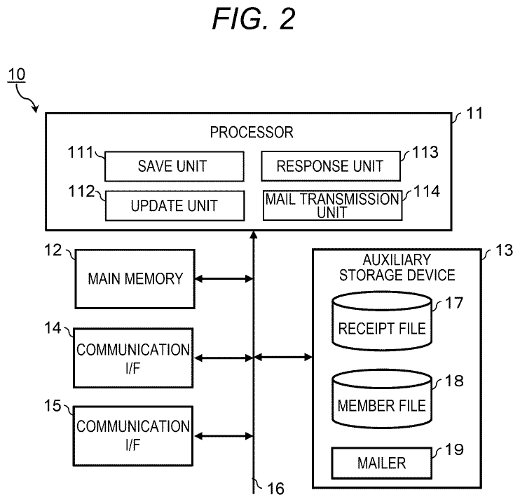

FIG. 2 is a block diagram of the receipt server 10. The receipt server 10 is provided with a processor 11, a main memory 12, an auxiliary storage device 13, a first communication interface 14, a second communication interface 15, a system transmission path 16, and so on. The system transmission path 16 includes an address bus, a data bus, control signal lines, and so on. The system transmission path 16 couples the processor 11 and other units to each other directly, or via a signal input-and-output circuit, and transmits data signals which are mutually received or transmitted therebetween.

The receipt server 10 couples the processor 11, the main memory 12, the auxiliary storage device 13, the first communication interface 14, and the second communication interface 15 to each other with the system transmission path 16.

The processor 11 controls each unit so as to realize a variety of functions as the receipt server 10 in conjunction with an operating system and/or an application program. The processor 11 is, for example, a central processing unit (CPU). The processor 11 is preferably a multi-core processor, which includes a plurality of processor cores, and is capable of executing a plurality of processes in parallel to each other.

The main memory 12 includes a nonvolatile memory area and a volatile memory area. The main memory 12 stores the operating system and/or the application program in the nonvolatile memory area. The main memory 12 may store data which is necessary for the processor 11 to execute control processing or the like in the nonvolatile memory area or the volatile memory area. The main memory 12 uses the volatile memory area as a work area in which data can be rewritten as appropriate by the processor 11. The nonvolatile memory area is, for example, a read only memory (ROM). The volatile memory area is, for example, a random access memory (RAM).

The auxiliary storage device 13 is, for example, an electrically erasable programmable read-only memory (EEPROM), a hard disk drive (HDD), or a solid-state drive (SSD). The auxiliary storage device 13 stores data which is used by the processor 11 when performing a variety of types of processing, data which is generated by the processing in the processor 11, and so on. The auxiliary storage device 13 can store the application program described above in some cases.

The first communication interface 14 is an interface for performing data communication with the POS terminals 20 of the respective stores 2 via the first communication network NWa. The second communication interface 15 is an interface for performing data communication with the information terminal 30 or the computer device 50 via the second communication network NWb.

The receipt server 10 uses a part of the storage area of the auxiliary storage device 13 as an area for a receipt file 17 and an area for a member file 18. The receipt server 10 may also store, in the auxiliary storage device 13, application software for performing generation and transmission of e-mails, such as mailer 19. It should be noted that the mailer 19 may be stored in the main memory 12 instead of the auxiliary storage device 13.

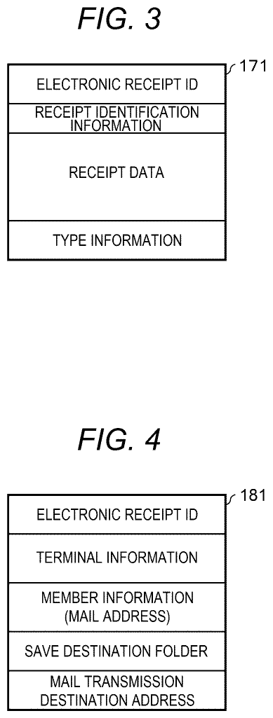

The receipt file 17 is a data file for accumulating receipt records 171 (see FIG. 3) generated for each instance of receipt data received from the POS terminals 20.

FIG. 3 is a schematic diagram showing a data structure of the receipt record 171. As shown in the drawing, the receipt record 171 includes the electronic receipt ID, receipt identification information, the receipt data, and type information. The electronic receipt ID is displayed on the top screen of the information terminal 30 when the electronic receipt member becomes the buyer, and can be read by the POS terminal 20. The electronic receipt ID is transmitted to the receipt server 10 from the POS terminal 20 together with the receipt data.

The receipt identification information is provided for the electronic receipt member to identify the receipt. For example, there can be information indicating when the receipt was issued, at which store that merchandise was bought, or the like. In other words, the receipt identification information consists of, for example, a transaction date, a store name, and a settlement amount as included in the receipt data. The receipt identification information may include other information.

The type information is information indicating a type of the receipt issued from the POS terminal 20. For example, the type may be a return receipt which is issued when registering merchandise returned by the buyer at the POS terminal 20, a correction receipt which is issued when performing a correction in a cash-register-minus mode of the POS terminal 20 when there was an error in the content of the transaction, and so on and additionally a purchase receipt which is issued when registering merchandise purchased by the buyer at the POS terminal 20. The type information is information for identifying the type of the receipt such as the purchase receipt, the return receipt, or the correction receipt. The type information is included in the receipt data generated by the POS terminal 20.

The member file 18 is a data file for accumulating the member record 181 (see FIG. 4) generated for each of the electronic receipt members.

FIG. 4 is a schematic diagram showing a data structure of the member record 181. As shown in the drawing, the member record 181 includes the electronic receipt ID, terminal information, member information, a save destination folder, and a mail transmission destination address. The terminal information is information related to the information terminal 30 owned by the electronic receipt member identified by the electronic receipt ID. For example, a terminal ID of the information terminal 30, an IP address, and so on are included in the terminal information. The member information is information related to the electronic receipt member identified by the electronic receipt ID. For example, a name and a mail address are included in the member information.

The destination save holder is information representing the path of the folder which is set by the electronic receipt member as a save place in which the image file obtained by converting the image of the receipt displayed on the display device of the information terminal 30 is to be saved. The save place identified by the save destination folder is a part of a storage area of, for example, an internal storage 32 (see FIG. 5) of the information terminal 30 or an external memory 40 (see FIG. 5). The electronic receipt member can store the image file of the receipt image in a storage unit of the information terminal 30 identified by the save destination folder.

The mail transmission destination address is a mail address which is set by the electronic receipt member as a transmission destination when transmitting the image file obtained by converting the image of the receipt displayed on the display device of the information terminal 30 as an attachment file of an e-mail. The electronic receipt member can store the image file of the receipt image in a storage unit of the computer device 50 for which that e-mail address is set.

A consumption tax payer can make use of the receipt as an eligible invoice by converting the image of a receipt into an image file and then storing the image file if the receipt issued by the store 2 is a receipt corresponding to the invoice system. Therefore, when the electronic receipt member (the tax payer) stores the image file of the receipt image in the information terminal 30, the electronic receipt member registers the save destination folder for the operating company of the electronic receipt service. When storing the image file of the receipt image in the computer device 50, the electronic receipt member registers the mail address of the computer device 50 for the operating company of the electronic receipt service as the mail transmission destination address. It should be noted that the electronic receipt member may register either of a save destination folder or a mail transmission destination address, or register both.

The processor 11 of the receipt server 10 having the receipt file 17, the member file 18, and the mailer 19 has functions as a save unit 111, an update unit 112, a response unit 113, and a mail transmission unit 114.

The save unit 111 provides a function of generating the receipt record 171 based on the receipt data received from each of the POS terminals 20 via the first communication network NWa, and then saving the receipt record 171 in the receipt file 17. When the save unit 111 receives the receipt data from the POS terminal 20, the save unit 111 obtains the electronic receipt ID received together with that receipt data. The save unit 111 extracts the receipt identification information such as the transaction date, the store name, and the settlement amount from the receipt data. The save unit 111 also obtains the type information from the receipt data. In this way, the save unit 111 generates the receipt record 171 with the electronic receipt ID, the receipt identification information, the receipt data, and the type information, and then adds the receipt record 171 to the receipt file 17. It should be noted that when the type information indicates a correction receipt, the receipt record 171 for the originally issued purchase receipt for the transaction that was corrected in the cash-register-minus mode also still exists in the receipt file 17. The save unit 111 can change the type information in the receipt record 171 for the original purchase receipt, a so-called original receipt, to indicate the original purchase receipt has been superseded by a corrected receipt.

The update unit 112 provides a function of updating the member record 181 stored in the member file 18 based on update data of the member record 181 received from the information terminal 30 via the second communication network NWb. When the update unit 112 receives update data of, for example, the save destination folder from the information terminal 30, the update unit 112 updates the save destination folder of the member record 181 including the electronic receipt ID of the electronic receipt member as the owner of that information terminal 30 with a content of the update data. When the update unit 112 receives the update data of, for example, the mail transmission destination address from the information terminal 30, the update unit 112 updates the mail transmission destination address of the member record 181 including the electronic receipt ID of the electronic receipt member as the owner of that information terminal 30 with a content of the update data.

The response unit 113 provides a function of responding to a receipt displaying request from the information terminal 30 with the electronic receipt issued to the electronic receipt member. When the response unit 113 receives a command of the receipt displaying request from the information terminal 30, the response unit 113 extracts the receipt record 171 which is stored in the receipt file 17 in association with the electronic receipt ID included in that command. Then, the response unit 113 generates data of the receipt list image based on the receipt identification information of the receipt record 171 thus extracted. The response unit 113 transmits the data for the receipt list image to the information terminal 30 that sent the receipt displaying request. Subsequently, when receiving the command of the receipt request from the information terminal 30, the response unit 113 obtains the receipt data of the receipt identified by the receipt identification information included in that command. The response unit 113 generates the data of the receipt image in, for example, a hypertext markup language (HTML) format based on that receipt data, and then transmits that data to the information terminal 30. At the information terminal 30 which receives the data in the HTML format, the image of the receipt may be displayed on a touch panel 35 by a function of a browser other application software provided on the information terminal 30.

The response unit 113 provides a function of responding to a receipt narrowing-down request from the information terminal 30 with a receipt satisfying the narrowing-down conditions out of all the electronic receipts issued to the electronic receipt member (owner of that information terminal 30). When the response unit 113 receives a command of the receipt narrowing-down request from the information terminal 30, the response unit 113 extracts the receipt record 171 which satisfies the narrowing-down conditions out of the receipt records 171 stored in the receipt file 17 in association with the electronic receipt ID included in that command. For example, when the narrowing-down condition is the original receipt, the receipt record 171 the type information of which is the information representing the original receipt is extracted. Then, the response unit 113 generates data of the receipt list image of the receipts which satisfy the narrowing-down conditions based on the receipt identification information of the receipt records 171 thus extracted. The response unit 113 transmits the data for the receipt list image to the information terminal 30 that sent the receipt narrowing-down request.

The mail transmission unit 114 provides a function of transmitting an e-mail with an image file of the receipt image attached. When the mail transmission unit 114 receives a mail transmission request from the information terminal 30, the mail transmission unit 114 generates the image file in a portable document format (PDF. Specifically, since the data of the receipt image is converted into an image file compressed in, for example, experts group (JPEG) joint photographic format in a the information terminal 30 and, then that image file is uploaded to the receipt server 10, the mail transmission unit 114 converts that image file into an image file in PDF. Then, the mail transmission unit 114 searches the member file 18 to obtain the mail address of the electronic receipt member and the mail transmission destination address set by that electronic receipt member, and then transmits an e-mail to the mail address of the electronic receipt member and the set mail transmission destination address.

### Description of Information Terminal

FIG. 5 is a block diagram of the information terminal 30. The information terminal 30 is provided with a processor 31, an internal storage 32, a wireless communication unit 33, a memory interface 34, a touch panel 35, a camera 36, a sound circuit 37, and a system transmission path 38.

The system transmission path 38 includes an address bus, a data bus, control signal lines, and so on. The system transmission path 38 couples the processor 31 and other units to each other directly, or via a signal input-and-output circuit, and transmits data signals which are mutually received or transmitted therebetween.

The information terminal 30 couples the processor 31, the internal storage 32, and the wireless communication unit 33 to each other with the system transmission path 38 to thereby constitute a computer. Further, the information terminal 30 couples the memory interface 34, the touch panel 35, the camera 36, the sound circuit 37, and so on with the system transmission path 38 via a signal input-and-output circuit or the like. The memory interface 34 is an interface which transmits and receives data signals with the external memory 40 which is detachably attached. The external memory 40 is typically an SD memory card, a mini-SD card, a micro-SD card, or the like. The touch panel 35 functions as the display device and an input device of the information terminal 30. The camera 36 functions as an imaging device of the information terminal 30. The sound circuit 37 is a circuit which controls a microphone 41 and a speaker 42 to make a voice call available. It should be noted that the interfaces, the devices, the circuits to be coupled to the system transmission path 38 are not limited to those described above. Other interfaces, devices, circuits, and so on may be coupled thereto.

The processor 31 controls each unit so as to realize a variety of types of functions of the information terminal 30 in conjunction with an operating system or an application program. The processor 31 is, for example, a CPU.

The internal storage 32 is a storage device incorporated in a chassis of the information terminal 30. The internal storage 32 stores the operating system or the application program. The internal storage 32 stores data which is necessary for the processor 31 to execute processing for controlling each unit in some cases.

The wireless communication unit 33 is for performing wireless voice communication or wireless data communication with a base station coupled to the second communication network NWb.

The information terminal 30 having such a configuration stores the electronic receipt app 43 in the internal storage 32. It should be noted that the electronic receipt app 43 may be stored in the external memory 40. A method of installing the electronic receipt app 43 in the inner storage 32 or the external memory 40 is not particularly limited. The electronic app 43 delivered with the communication via the second communication network NWb may be received, and then installed in the internal storage 32 or the external memory 40. Alternatively, the electronic receipt app 43 may be recorded on a removable recording medium, and then installed in the internal storage 32 or the external memory 40. The recording medium may have any configuration providing the recording medium is capable of storing the programs and is capable of being read by the device similarly to a CD-ROM, a memory card, or the like.

The information terminal 30 in which the electronic receipt app 43 is installed is capable of performing data communication with the receipt server 10 using the wireless communication with the wireless communication unit 33. Here, the wireless communication unit 33 functions as a communication unit for performing communication with the receipt server 10. Further, the processor 31 of the information terminal 30 has functions as a control unit 311, a generation unit 312, and an execution unit 313.

The control unit 311 provides a function of displaying the receipt image based on the receipt data received from the receipt server 10 on a screen of the display device together with an instruction part for instructing processing related to the storage of that receipt image. The display device is the touch panel 35. The control unit 311 makes the touch panel 35 display the receipt image. Further, the control unit 311 displays the instruction part on the screen of the touch panel 35 on which the receipt image is displayed. The instruction part is a button image which functions as a softkey. The instruction part instructs the processing related to the storage of the receipt image. The processing related to the storage includes first processing of saving an image file obtained by changing the information of a receipt image into an electronic file in the storage unit provided to that information terminal 30, and second processing for transmitting an e-mail with an image file to a predetermined mail address. The storage unit provided to the information terminal 30 is the internal storage 32 or the external memory 40. The instruction part alternatively instructs the first processing or the second processing.

The generation unit 312 provides a function of generating the image file obtained upon changing the information in the receipt image displayed on the display device into an electronic file. The generation unit 312 captures the image of the receipt displayed on the touch panel 35 using a screenshot function, a scroll capture function, or the like. Then, the generation unit 312 converts the image thus captured into, for example, an image file in the JPEG format to thereby generate the image file obtained by changing the information of the receipt image into an electronic file.

The execution unit 313 provides a function of executing processing related to the storage instructed by the instruction part on the image file generated by the generation unit 312. For example, when the processing related to the storage is the first processing, the execution unit 313 executes processing for saving the image file in the storage unit designated as the save destination folder. For example, when the processing related to the storage is the second processing, the execution unit 313 executes processing for transmitting the image file as an attachment to an e-mail to the mail transmission destination address.

### Description of Electronic Receipt System Operation

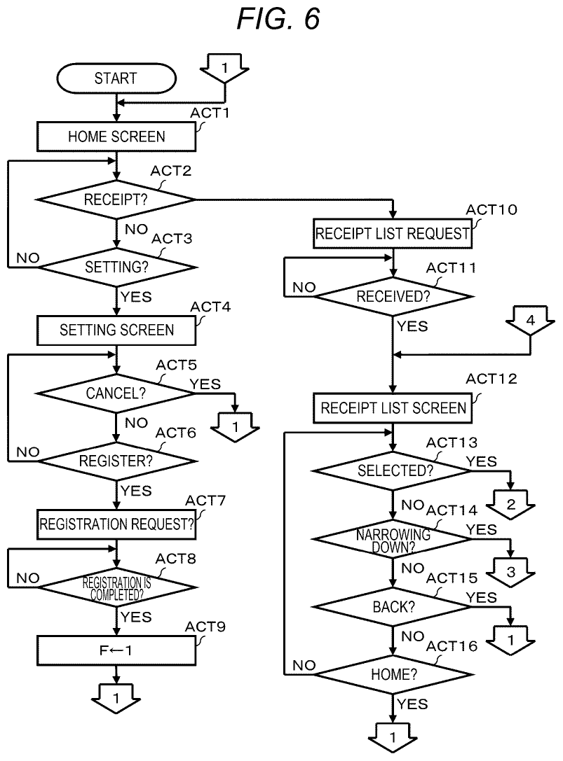

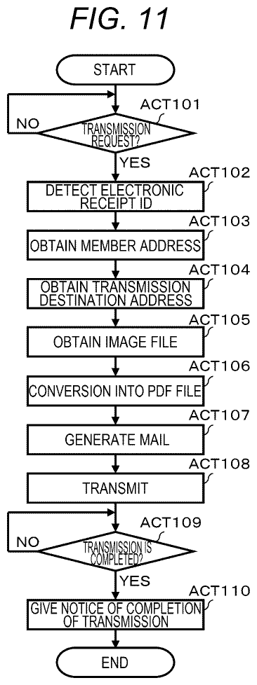

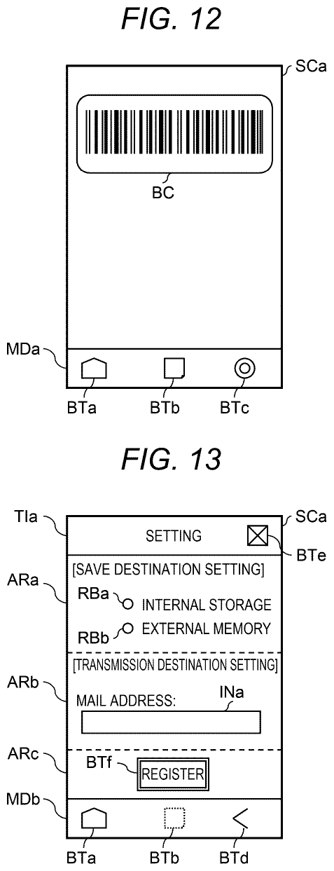

FIG. 6 through FIG. 10 provide a flowchart representing a procedure of information processing executed by the processor 31 of the information terminal 30. FIG. 11 is a flowchart of information processing executed by a processor 11 of the receipt server 10. FIG. 12 through FIG. 23 show examples of a variety of images to be displayed on the touch panel 35 of the information terminal 30.

Certain aspects of the electronic receipt system 100 will hereinafter be described using the drawings. It should be noted that the specific content and example procedures of the information processing described are illustrative only and the disclosure is not limited thereto. As long as substantially the same functions as described can be provided, the specific content and procedures may be modified as appropriate. Further, the example screen images are also non-limiting. The arrangement and variety of depicted elements, text, and so on may be modified as appropriate.

In the information terminal 30, when the electronic receipt app 43 is invoked (started), the processor 31 starts the information processing in the procedure represented by the flowchart shown in FIG. 6. As ACT1, the processor 31 sets the home screen SCa (see FIG. 12) on the screen of the touch panel 35.

FIG. 12 shows an example of an image displayed in the home screen SCa. As shown in the drawing, a barcode BC is displayed in the home screen SCa. The barcode BC is obtained by converting the electronic receipt ID which is assigned to the electronic receipt member as the owner of that information terminal 30 into a barcode as a machine-readable code. It should be noted that a two-dimensional code representing the electronic receipt ID may be displayed instead of the barcode. Further, a part of the home screen SCa is used as a mode area MDa. Further, in the home screen SCa, a home button BTa, a receipt BTb, and a setting button BTc are disposed in the mode area MDa. The home button BTa, the receipt button BTb, and the setting button BTC are all softkeys. The home button BTa, the receipt button BTb, and the setting button BTc may be referred to as icons or the like. It should be noted that the softkeys disposed in the mode area MDa are not limited to the home button BTa, the receipt button BTb, and the setting button BTc. Softkeys (icons) representing other buttons may be disposed.

The home button BTa is an operator for receiving an instruction of restoring a default mode. The default mode is a mode of displaying the home screen SCa. Therefore, in the home screen SCa, input of the home button BTa is invalidated. The receipt button BTb is an operator for receiving a change instruction to a receipt displaying mode. The receipt displaying mode is a mode for displaying a electronic receipt. The setting button BTc is an operator for receiving a change instruction to a setting mode. The setting mode is a mode for setting, for example, the save destination folder and the mail transmission destination address in the member file 18.

The user of the information terminal 30, namely the electronic receipt member, taps the receipt button BTb for displaying the electronic receipt. Further, when registering the save destination folder or the mail transmission destination address on the member file 18, or when changing the save destination folder or the mail transmission destination address once registered, the electronic receipt member taps the setting button BTc.

The processor 31 of the information terminal 30 proceeds to ACT2. As ACT2, the processor 31 checks whether the receipt button BTb was tapped. When the receipt button BTb was not tapped, the processor 31 proceeds to ACT3. As ACT3, the processor 31 confirms whether the setting button BTc was tapped. When the setting button BTc was not tapped, the processor 31 returns to ACT2.

As described above, the processor 31 of the information terminal 30 awaits a tap on the receipt button BTb or a tap on the setting button BTc in ACT2 and ACT3.

When the processor 31 detects a tap on the setting button BTc in the standby state of ACT2 and ACT3, the processor 31 proceeds to ACT4. As ACT4, the processor 31 sets a setting screen SCb (see FIG. 13) on the screen of the touch panel 35.

FIG. 13 shows an example of an image displayed in the setting screen SCb. As shown in the drawing, the setting screen SCb is zoned into a title area TIa, a save destination setting area ARa, a transmission destination setting area ARb, an operation button area ARc, and a mode area MDb. Further, in the title area TIa, a cancel button BTe is disposed together with a title “SETTING.”

Radio buttons RBa, RBb for selecting the save destination of the image file is set to the internal storage 32 or the external memory 40 are disposed in the save destination setting area ARa. For example, the electronic receipt member who wants to change an image of a receipt which can be an eligible invoice into an electronic file and store the file in the information terminal determines the 30 whether storage destination is set to the internal storage 32 or is set to the external memory 40. Then, when the storage destination is set to the internal storage 32, the electronic receipt member selects the radio button RBa. When the storage destination is set to the external memory 40, the electronic receipt member selects the radio button RBb.

An input part INa for the mail address is disposed in the transmission destination setting area ARb. For example, the electronic receipt member who wants to change the image of the receipt (which can be the eligible invoice) into an electronic file and store the file in the computer device 50 coupled to the second communication network NWb inputs a mail address for that computer device 50 in the input part INa.

A REGISTER button BTf is disposed in the operation button area ARc. The REGISTER button BTf is a softkey. When the electronic receipt member registers the content input to the save destination setting area ARa or the transmission destination setting area ARb on the member file 18, the electronic receipt member taps the REGISTER button BTf. It should be noted that when terminating the processing in the setting mode without the registration, the electronic receipt member taps the cancel button BTe.

In the mode area MDb, a back button BTd is disposed in addition to the home button BTa and the receipt button BTb. The back button BTd is an operator for receiving an instruction of going back to the last mode.

The processor 31 of the information terminal 30 which sets the setting screen SCb on the screen of the touch panel 35 proceeds to ACT5. As ACT5, the processor 31 checks whether the cancel button BTe was tapped. When the cancel button BTe was not tapped, the processor 31 proceeds to ACT6. As ACT6, the processor 31 confirms whether the REGISTER button BTf was tapped. When the REGISTER button BTf was not tapped, the processor 31 returns to ACT5.

As described above, the processor 31 of the information terminal 30 after displaying the setting screen SCb awaits a tap on the cancel button BTe or a tap on the REGISTER button BTf in ACT5 and ACT6.

When the processor 31 detects a tap on the cancel button BTe in the standby state of ACT5 and ACT6, the processor 31 returns to ACT1. In other words, the processor 31 restores the home screen SCa on the screen of the touch panel 35 from the setting screen SCb. It should be noted that also when a tap on the back button BTd is detected, the processor 31 returns to ACT1. In other words, the processor 31 restores the home screen SCa on the screen of the touch panel 35 from the setting screen SCb.

When the processor 31 detects a tap on the REGISTER button BTf in the standby state in ACT5 and ACT6, the processor 31 proceeds to ACT7. As ACT7, the processor 31 performs control of transmitting a registration request command to the receipt server 10. Due to this control, the registration request command is transmitted wirelessly from the wireless communication unit 33. The registration request command is transmitted to the receipt server 10 via the second communication network NWb. The electronic receipt ID set to the information terminal 30 is included in the registration request command. Further, when the information of the save destination folder was input to the save destination setting area ARa, that information is included. When the information of the mail transmission destination address was input to the transmission destination setting area ARb, that information is included.

The processor 11 of the receipt server 10 upon receiving the registration request command operates as the update unit 112. Specifically, the processor 11 updates the information of the save destination folder or the mail transmission destination address of the member record 181 identified by the electronic receipt ID included in the registration request command. Specifically, when the save destination folder is included in the registration request command, the save destination folder for the member record 181 is updated with the information in the registration request command. When the mail transmission destination address is included in the registration request command, the mail transmission destination address of the member record 181 is updated with the information in the registration request command. When the processor 11 completes the update of the member record 181, the processor 11 transmits a registration completion command to the information terminal 30.

The processor 31 of the information terminal 30, after transmitting the registration request command in ACT7, proceeds to ACT8. As ACT8, the processor 31 awaits the registration completion command. When the processor 31 receives the registration completion command via the wireless communication unit 33, the processor 31 proceeds to ACT9. As ACT9, the processor 31 sets a setting completion flag F to “1.” The setting completion flag F is a single bit data stored in the internal storage 32. The setting completion flag F is information for identifying whether at least one of the information of the save destination folder and the information of the mail transmission destination address was set in the member record 181 identified by the electronic receipt ID set to the information terminal 30. In the present embodiment, the setting completion flag F value representing setting completion is defined as “1,” and the setting completion flag F value representing setting incompletion is defined as “0.” The information of the setting completion flag F stored in the internal storage 32 is not erased after the information terminal 30 is powered off.

The processor 31 then returns to ACT1. The processor 31 restores the home screen SCa on the screen of the touch panel 35 from the setting screen SCb.

When the processor 31 detects a tap on the receipt button BTb in the standby state of ACT2 and ACT3, the processor 31 proceeds to ACT10. As ACT10, the processor 31 performs control for transmitting a receipt list request command to the receipt server 10. Due to this control, the receipt list request command is transmitted wirelessly from the wireless communication unit 33. The receipt list request command is transmitted to the receipt server 10 via the second communication network NWb. The electronic receipt ID set to the information terminal 30 is included in the receipt list request command.

The processor 11 of the receipt server 10 receives the receipt list request command as the response unit 113. Specifically, the processor 11 extracts the receipt record 171 stored in the receipt file 17 in association with the electronic receipt ID included in the receipt list request command. Then, the processor 11 generates data for the receipt list image based on the receipt identification information in the receipt record 171 thus extracted. The processor 11 transmits the data for the receipt list image to the information terminal 30 that sent the receipt displaying request.

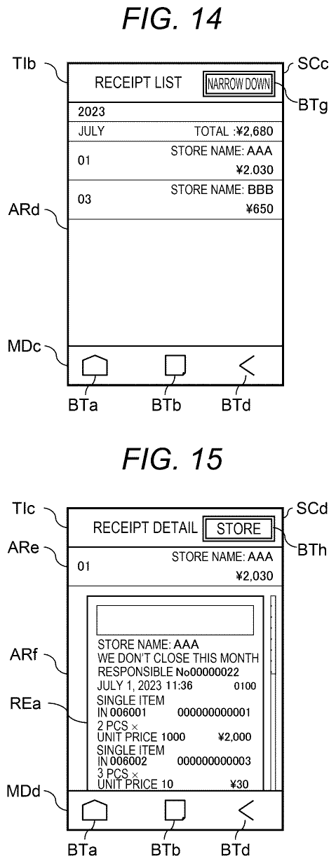

The processor 31 of the information terminal 30 then proceeds to ACT11. As ACT11, the processor 31 awaits reception of the data for the receipt list image. When the processor 31 receives the data for the receipt list image via the wireless communication unit 33, the processor 31 proceeds to ACT12. As ACT12, the processor 31 sets a receipt list screen SCc (see FIG. 14) on the screen of the touch panel 35.

FIG. 14 shows an example of an image displayed as the receipt list screen SCc. As shown in the drawing, the receipt list screen SCc is zoned into a title area TIb, a receipt list area ARd, and a mode area MDc. Further, in the title area TIb, a NARROW DOWN button BTg is disposed together with a title “RECEIPT LIST.” The NARROW DOWN button BTg is a softkey. The NARROW DOWN button BTg is an operator for receiving the narrowing-down conditions for the receipt. As the narrowing-down conditions, there are cited a store which is an issuer of the receipt, a type of the receipt, and so on.

The receipt list image is displayed in the receipt list area ARd. The receipt list image is an image in which the receipt identification information (e.g., a date, a store name, and a settlement amount) of each of electronic receipts issued on a certain transaction date as a unit is arranged in the order of date.

In the mode area MDc, the home button BTa, the receipt button BTb, and the back button BTd are displayed similarly to the setting screen SCb. It should be noted that the input of the receipt button BTb is invalidated.

When the electronic receipt member who confirmed the receipt list screen SCc displays the details of the receipt identified by the receipt identification information, the electronic receipt member taps a row in which that receipt identification information is displayed. When narrowing down the receipt list, the electronic receipt member taps the NARROW DOWN button BTg. When restoring the home screen SCa on the screen of the touch panel 35, the electronic receipt member taps the home button BTa or the back button BTd.

The processor 31 of the information terminal 30 which displays the receipt list screen SCc proceeds to ACT13. As ACT13, the processor 31 confirms whether a receipt was designated, namely whether a row in which the receipt identification information was displayed was selected. When the row in which the receipt identification information is displayed was not selected, the processor 31 proceeds to ACT14. As ACT14, the processor 31 confirms whether the NARROW DOWN button BTg was tapped. When the NARROW DOWN button BTg was not tapped, the processor 31 proceeds to ACT15. As ACT15, the processor 31 confirms whether the back button BTd was tapped. When the back button BTd was not tapped, the processor 31 proceeds to ACT16. As ACT16, the processor 31 confirms whether the home button BTa was tapped. When the home button BTa was not tapped, the processor 31 returns to ACT13.

As described above, the processor 31 of the information terminal 30 displaying the receipt list screen SCc awaits selection of the row in which the receipt identification information is displayed, a tap on the NARROW DOWN button BTg, a tap on the back button BTd or the home button BTa in ACT13 through ACT16. In this standby state, when a tap on the back button BTd or the home button BTa is detected, the processor 31 returns to ACT1. In other words, the processor 31 restores the home screen SCa on the screen of the touch panel 35 from the receipt list screen SCc.

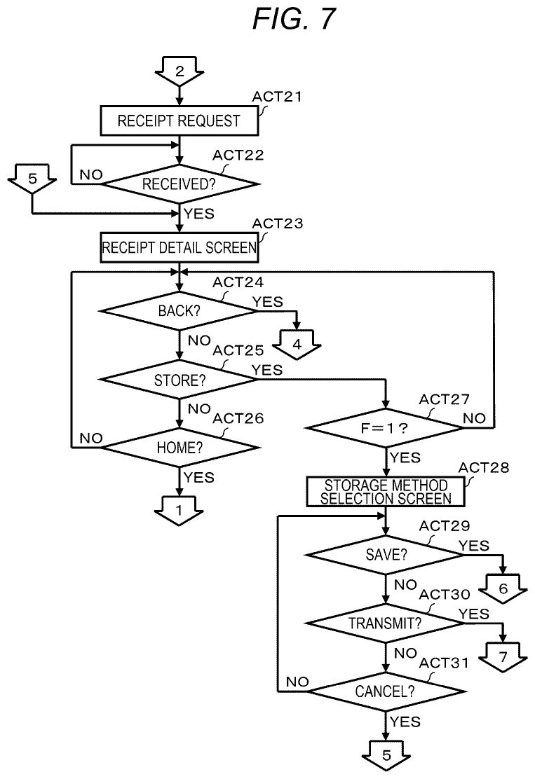

However, when the processor 31 detects the selection of the row in which the receipt identification information is displayed in the standby state off ACT13 through ACT16, the processor 31 proceeds to ACT21 in FIG. 7. As ACT21, the processor 31 performs control for transmitting a receipt request command to the receipt server 10. Due to this control, the receipt request command is transmitted wirelessly from the wireless communication unit 33. The receipt request command is transmitted to the receipt server 10 via the second communication network NWb. The receipt identification information thus selected is included in the receipt request command together with the electronic receipt ID set to the information terminal 30.

The processor 11 of the receipt server 10 receives the receipt request command and operates as the response unit 113. Specifically, the processor 11 extracts the receipt record 171 which has the receipt data including the receipt identification information out of all the receipt records 171 stored in the receipt file 17 in association with the electronic receipt ID included in the receipt request command. Then, the processor 11 generates data for the receipt image in, for example, the HTML format based on the receipt data of the receipt record 171 thus extracted. The processor 11 transmits the data for the receipt image to the information terminal 30 which sent the receipt request.

The processor 31 of the information terminal 30 then proceeds to ACT22. As ACT22, the processor 31 awaits reception of the data for the receipt image. When the processor 31 receives the data for the receipt image via the wireless communication unit 33, the processor 31 proceeds to ACT23. As ACT23, the processor 31 sets a receipt detail screen SCd (see FIG. 15) on the screen of the touch panel 35.

FIG. 15 shows an example of an image displayed on the receipt detail screen SCd. As shown in the drawing, the receipt detail screen SCd is zoned into a title area TIc, a receipt identification information area ARe, a receipt image area ARf, and a mode area MDd. Further, in the title area TIc, a STORE button BTh is disposed together with a title “RECEIPT DETAIL.” The STORE button BTh is a softkey. The STORE button BTh is an operator for instructing processing related to the storage of the receipt image. In other words, the STORE button BTh functions as the instruction part.

The receipt identification information which was selected in the receipt list image SCc is displayed in the receipt identification information area ARe. Further, as a function of a browser or the like installed in the information terminal 30, image REa of the receipt identified by the receipt an identification information thus selected is displayed in the receipt image area ARf. In the mode area MDd, the home button BTa, the receipt button BTb, and the back button BTd are displayed similarly to the receipt list screen SCc.

As described above, the receipt detail screen SCd is a screen on which the receipt image based on the receipt data received from the receipt server 10 is displayed together with an instruction part for instructing the processing related to the storage of that receipt image. Here, the processor 31 executes the processing in ACT23 to thereby realize functions as the control unit 311.

The processor 31 of the information terminal 30 then proceeds to ACT24. As ACT24, the processor 31 confirms whether the back button BTd was tapped. When the back button BTd was not tapped, the processor 31 proceeds to ACT25. As ACT25, the processor 31 checks whether the STORE button BTh was tapped. When the STORE button BTh was not tapped, the processor 31 proceeds to ACT26. As ACT26, the processor 31 checks whether the home button BTa was tapped. When the home button BTa was not tapped, the processor 31 returns to ACT24.

As described above, the information terminal 30 displays the receipt detail screen SCd and the processor 31 awaits a tap on the back button BTd, a tap on the STORE button BTh, or a tap on the home button BTa in ACT24 through ACT26. In this standby state, when a tap on the back button BTd is detected, the processor 31 returns to ACT12 in FIG. 6. In other words, the processor 31 restores the receipt list screen SCc on the screen of the touch panel 35 from the receipt detail screen SCd. When a tap on the home button BTa is detected, the processor 31 returns to ACT1 in FIG. 6. In other words, the processor 31 restores the home screen SCa on the screen of the touch panel 35 from the receipt detail screen SCd.

When the STORE button BTh was tapped in the standby state in ACT24 through ACT26, the processor 31 proceeds to ACT27. As ACT27, the processor 31 checks the setting completion flag F saved in the internal storage 32. Here, when the setting completion flag F is reset to “0,” namely when the electronic receipt member did not set the save destination folder and the mail transmission destination address, the processor 31 returns to ACT24. In other words, the processor 31 invalidates the input of the STORE button BTh, and continues the standby state in ACT24 through ACT26.

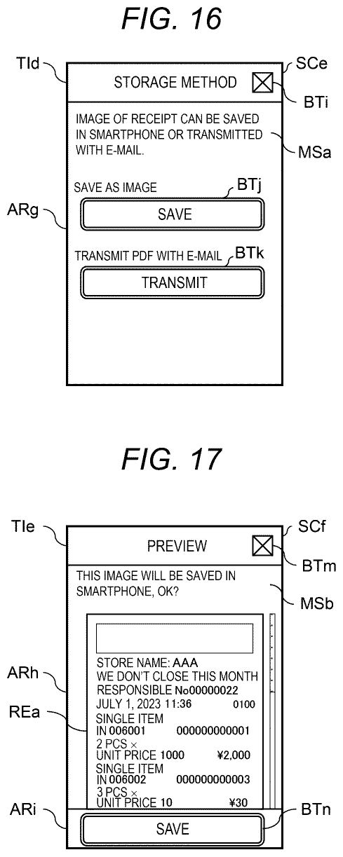

In contrast, when the setting completion flag F is set to “1,” namely when the electronic receipt member set the save destination folder or the mail transmission destination address, the processor 31 proceeds to ACT28. As ACT28, the processor 31 sets a storage method selection screen SCe (see FIG. 16) on the screen of the touch panel 35.

FIG. 16 shows an example of an image displayed in the storage method selection screen SCe. As shown in the drawing, the storage method selection screen SCe is zoned into a title area TId and an operation button area ARg. In the title area TId, a cancel button BTi is disposed together with a title “STORAGE METHOD.” In the operation button area ARg, a SAVE button BTj and TRANSMIT button BTk are disposed together with a message MSa for explaining storage methods of an image file. The SAVE button BTj is an operator for selecting a method of saving the image file in the storage unit of the information terminal 30 as the storage method based on the first processing. The TRANSMIT button BTk is an operator for selecting a method of saving the image file by transmitting the image file with an e-mail to the computer device 50 located outside as the storage method based on the second processing.

The processor 31 of the information terminal 30 which sets the storage method selection screen SCe on the screen of the touch panel 35 proceeds to ACT29. As ACT29, the processor 31 confirms whether the SAVE button BTj was tapped. When the SAVE button BTj was not tapped, the processor 31 proceeds to ACT30. As ACT30, the processor 31 confirms whether the TRANSMIT button BTk was tapped. When the TRANSMIT button BTk was not tapped, the processor 31 proceeds to ACT31. As ACT31, the processor 31 confirms whether the cancel button BTi was tapped. When the cancel button BTi was not tapped, the processor 31 returns to ACT29.

As described above, the processor 31 of the information terminal 30 which sets the storage method selection screen SCe on the screen of the touch panel 35 awaits a tap on the SAVE button BTj, a tap on the TRANSMIT button BTk, or a tap on the cancel button BTi in ACT29 through ACT31. In this standby state, when a tap on the cancel button BTi is detected, the processor 31 returns to ACT23. In other words, the processor 31 restores the receipt detail screen SCd on the screen of the touch panel 35 from the storage method selection screen SCe.

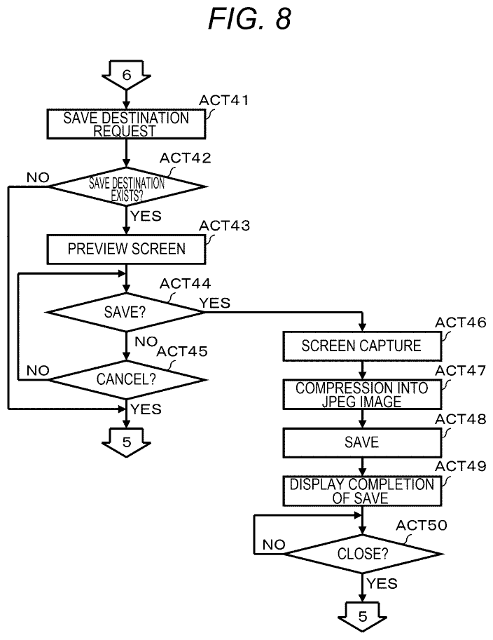

When the SAVE button BTj was tapped in the standby state in ACT29 through ACT31, the processor 31 proceeds to ACT41 in FIG. 8. As ACT41, the processor 31 performs control of transmitting a save destination request command to the receipt server 10. Due to this control, the save destination request command is transmitted wirelessly from the wireless communication unit 33. The save destination request command is transmitted to the receipt server 10 via the second communication network NWb. The electronic receipt ID set to the information terminal 30 is included in the save destination request command.

The processor 11 of the receipt server 10 which received the save destination request command searches the member file 18 to confirm whether the information of the save destination folder exists in the member record 181 including the electronic receipt ID included in the save destination request command. When the information of the save destination folder exists, the processor 11 sends a response command including the information indicating the save destination folder back to the information terminal 30. In contrast, when the information indicating the save destination folder does not exist, the processor 11 sends a response command which does not include information for the save destination folder back to the information terminal 30.

The processor 31 of the information terminal 30 then proceeds to ACT42. As ACT42, the processor 31 checks whether the information indicating the save destination folder was obtained successfully. If the processor 31 receives a response command including the information for the save destination folder from the receipt server 10, the processor 31 determines that save destination folder information was obtained successfully. If the processor 31 receives a response command which does not include the information for the save destination folder from the receipt server 10, the processor 31 determines that the processor 31 failed to obtain the save destination folder information. If the processor fails to obtain the information for the save destination folder, the processor 31 returns to ACT23 in FIG. 7. The processor 31 restores the receipt detail screen SCd on the screen of the touch panel 35 from the storage method selection screen SCe.

In contrast, when the save destination folder information is obtained successfully, the processor 31 proceeds to ACT43. The processor 31 sets a preview screen SCf (see FIG. 17) on the screen of the touch panel 35.

FIG. 17 shows an example of an image displayed in the preview screen SCf. As shown in the drawing, the preview screen SCf is zoned into a title area TIe, a preview area ARh, and an operation button area ARi. In the title area TIe, a cancel button BTm is disposed together with a title “PREVIEW.” In the preview area ARh, a receipt image REa which was displayed in the last receipt detail screen SCd is displayed together with a message MSb of inquiring whether it is allowable to save the receipt previewed here as an image file. A SAVE button BTn is disposed in the operation button area ARg. The SAVE button BTn is a softkey. The SAVE button BTn is for receiving an instruction of saving the receipt displayed in the preview area ARh as an image file.

The processor 31 of the information terminal 30 which displays the preview image SCf proceeds to ACT44. As ACT44, the processor 31 confirms whether the SAVE button BTn was tapped. When the SAVE button BTn was not tapped, the processor 31 proceeds to ACT45. As ACT45, the processor 31 confirms whether the cancel button BTm was tapped. When the cancel button BTm was not tapped, the processor 31 returns to ACT44.

As described above, the processor 31 of the information terminal 30 which displays the preview screen SCf awaits a tap on the SAVE button BTn or a tap on the cancel button BTm in ACT44 and ACT45. In this standby state, when a tap on the cancel button BTm is detected, the processor 31 returns to ACT23 in FIG. 7. The processor 31 restores the receipt detail screen SCd on the screen of the touch panel 35 from the preview screen SCf.

When the processor 31 detects a tap on the SAVE button BTn in the standby state in ACT44 and ACT45, the processor 31 proceeds to ACT46. As ACT46, the processor 31 captures the image of the receipt displayed in the preview area ARh using the screenshot function or the scroll capture function. Then, as ACT47, the processor 31 converts the image thus captured into, for example, an image file in the JPEG format to thereby generate an image file obtained by changing the image of the receipt into an electronic file. Subsequently, as ACT48, the processor 31 save the image file in a folder of the internal storage 32 or the external memory 40 specified by the information of the save destination folder.

Here, the processor 31 executes the processing in ACT46 and ACT47 to thereby realize the function as the generation unit 312. The processor 31 executes the processing in ACT48 to thereby realize the function as the execution unit 313.

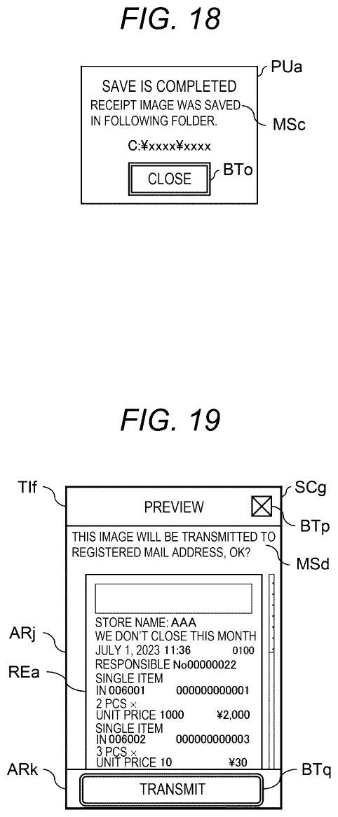

The processor 31 then proceeds to ACT49. As ACT49, the processor 31 makes the touch panel 35 display a pop-up image PUa (see FIG. 18) representing the completion of the save so as to overlap the preview screen SCf.

FIG. 18 is an example of the pop-up image PUa. As shown in the drawing, a CLOSE button BTo is disposed together with a message MSc representing that the image file is saved in the save destination folder. The CLOSE button BTo is a softkey. The CLOSE button BTo is an operator for receiving an instruction of closing the pop-up image PUa.

The processor 31 of the information terminal 30 which displays the pop-up image PUa on the touch panel 35 proceeds to ACT50. As ACT50, the processor 31 awaits a tap on the CLOSE button BTo. When a tap on the CLOSE button BTo is detected, the processor 31 returns to ACT23 in FIG. 7. The processor 31 restores the receipt detail screen SCd on the screen of the touch panel 35 from the preview screen SCf.

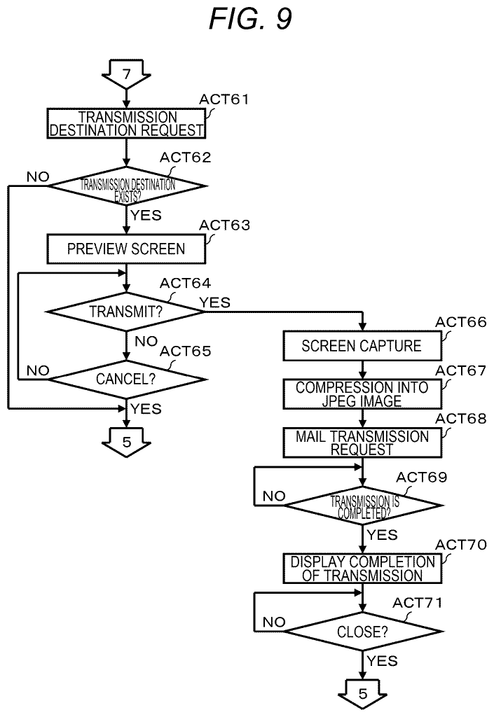

When the TRANSMIT button BTk was tapped in the standby state in ACT29 through ACT31 in FIG. 7, the processor 31 proceeds to ACT61 in FIG. 9. As ACT61, the processor 31 performs control of transmitting a transmission destination request command to the receipt server 10. Due to this control, the transmission destination request command is transmitted wirelessly from the wireless communication unit 33. The transmission destination request command is transmitted to the receipt server 10 via the second communication network NWb. The electronic receipt ID set to the information terminal 30 is included in the transmission destination request command.

The processor 11 of the receipt server 10 which received the transmission destination request command searches the member file 18 to confirm whether the information of the transmission destination address exists in the member record 181 including the electronic receipt ID included in the transmission destination request command. When the information of the mail transmission destination address exists, the processor 11 sends a response command back to the information terminal 30 including the mail transmission destination address. If the information indicating a mail transmission destination address does not exist, the processor 11 sends a response command which does not include the information of the mail transmission destination address back to the information terminal 30.

The processor 31 of the information terminal 30 then proceeds to ACT62. As ACT62, the processor 31 checks whether the mail transmission destination address was obtained successfully. If the processor fails to obtain the information indicating the mail transmission destination address, the processor 31 returns to ACT23 in FIG. 7. The processor 31 restores the receipt detail screen SCd on the screen of the touch panel 35 from the storage method selection screen SCe.

In contrast, when the information indicating the mail transmission destination address is obtained successfully, the processor 31 proceeds to ACT63. The processor 31 sets a preview screen SCg (see FIG. 19) on the screen of the touch panel 35.

FIG. 19 shows an example of an image displayed in the preview screen SCg. As shown in the drawing, the preview screen SCg is zoned into a title area TIf, a preview area ARj, and an operation button area ARk. In the title area TIf, a cancel button BTp is disposed together with a title “PREVIEW.” In the preview area ARj, a receipt image REa which was displayed in the last receipt detail screen SCd is displayed together with a message MSd of inquiring whether it is allowable to transmit the image file of the receipt previewed here attached to an e-mail. A TRANSMIT button BTq is disposed in the operation button area ARk. The TRANSMIT button BTq is a softkey. The TRANSMIT button BTq is an operator for receiving an instruction of transmitting the image file of the receipt displayed in the preview area ARj attached to an e-mail.

The processor 31 of the information terminal 30 then proceeds to ACT64. As ACT64, the processor 31 checks whether the TRANSMIT button BTq was tapped. When the TRANSMIT button BTq was not tapped, the processor 31 proceeds to ACT65. As ACT65, the processor 31 checks whether the cancel button BTp was tapped. When the cancel button BTp was not tapped, the processor 31 returns to ACT64.

As described above, the processor 31 of the information terminal 30 displays the preview screen SCg and awaits a tap on the TRANSMIT button BTq or a tap on the cancel button BTp in ACT64 and ACT65. In this standby state, when a tap on the cancel button BTp is detected, the processor 31 returns to ACT23 in FIG. 7. The processor 31 restores the receipt detail screen SCd on the screen of the touch panel 35 from the preview screen SCg.

When the processor 31 detects a tap on the TRANSMIT button BTq in the standby state of ACT64 and ACT65, the processor 31 proceeds to ACT66. As ACT66, the processor 31 captures the image of the receipt displayed in the preview area ARj in the preview screen SCg using the screenshot function or the scroll capture function. Then, as ACT67, the processor 31 converts the image thus captured into, for example, an image file in the JPEG format to thereby generate an image file obtained by changing the information of the receipt image into an electronic file. Subsequently, as ACT68, the processor 31 performs control of transmitting a mail transmission request command to the receipt server 10. Due to this control, the mail transmission request command is transmitted wirelessly from the wireless communication unit 33. The mail transmission request command is transmitted to the receipt server 10 via the second communication network NWb. The image file generated in the processing in ACT67 is included in the mail transmission request command together with the electronic receipt ID set to the information terminal 30.

Here, the processor 31 executes the processing in ACT66 and ACT67 to thereby realize the function as the generation unit 312. The processor 31 executes the processing in ACT68 to thereby realize the function of the execution unit 313.

FIG. 11 is a flowchart of information processing executed by the processor 11 of the receipt server 10 when receiving the mail transmission request command. As ACT101, the processor 11 awaits the mail transmission request command. When the processor 11 receives the mail transmission request command via the second communication interface 15, the processor 11 proceeds to ACT102. As ACT102, the processor 11 detects the electronic receipt ID from the mail transmission request command.

Then, as ACT103, the processor 11 searches the member file 18 using the electronic receipt ID. Then, when the processor 11 detects the member record 181 including the receipt ID, the processor 11 obtains the mail address from the member information of the member record 181 as ACT 104. Further, as ACT105, the processor 11 obtains the mail transmission destination address included in the member record 181.

Further, as ACT105, the processor 11 obtains the image file which is obtained by compressing the data of the receipt image in, for example, the JPEG format from the mail transmission request command. Then, as ACT106, the processor 11 converts the image file into an image file in PDF.

When the processor 11 completes the processing in ACT102 through ACT106, processor 11 proceeds to ACT107. As ACT107, the processor 11 activates the mailer 19. Then, the processor 11 generates an e-mail with the mailer 19. The e-mail uses the mail address of the member information obtained in ACT103 and the mail transmission destination address obtained in ACT104. The processor 11 attaches the image file converted into PDF in ACT106 to this e-mail.

After completing the formation of the e-mail, the processor 11 proceeds to ACT108. As ACT108, the processor 11 performs control of transmitting the e-mail. Due to this control, the e-mail is transmitted via the second communication network NWb. The electronic mail is ultimately received by the computer device 50 for which the mail transmission destination address was set.

As ACT109, the processor 11 awaits the completion of the transmission of the e-mail. When the transmission of the e-mail is completed, the processor 11 proceeds to ACT110. As ACT110, the processor 11 issues a transmission completion notice to the information terminal 30. With the above, the processor 11 terminates the information processing after the mail transmission request command is received. Here, the processor 11 executes the processing in ACT102 through ACT108 to thereby realize the function of the mail transmission unit 114.

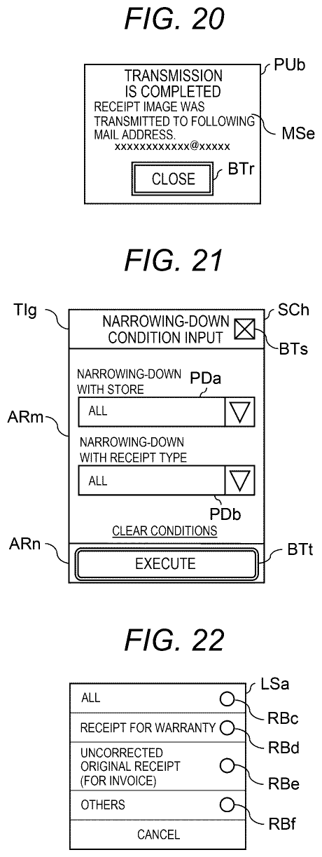

Referring back to the description of FIG. 9, the processor 31 of the information terminal 30 transmits the transmission request command and proceeds to ACT69. As ACT69, the processor 31 awaits the transmission completion notice. When the processor 31 receives the transmission completion notice (response command) from the receipt server 10, the processor 31 proceeds to ACT70. As ACT70, the processor 31 makes the touch panel 35 display a pop-up image PUb (see FIG. 20) indicating the transmission completion so as to overlap the preview screen SCg.

FIG. 20 is an example of the pop-up image PUb. As shown in the drawing, a CLOSE button BTr is disposed in the pop-up image PUb together with a message MSe indicating that the e-mail with the image file of the receipt image was transmitted. The CLOSE button BTr is a softkey. The CLOSE button BTr is an operator for receiving an instruction of closing the pop-up image PUb.

The processor 31 of the information terminal 30 displays the pop-up image PUb on the touch panel 35 and proceeds to ACT71. As ACT71, the processor 31 awaits a tap on the CLOSE button BTr. When a tap on the CLOSE button BTr is detected, the processor 31 returns to ACT23 in FIG. 7. The processor 31 restores the receipt detail screen SCd on the screen of the touch panel 35 from the preview screen SCg.

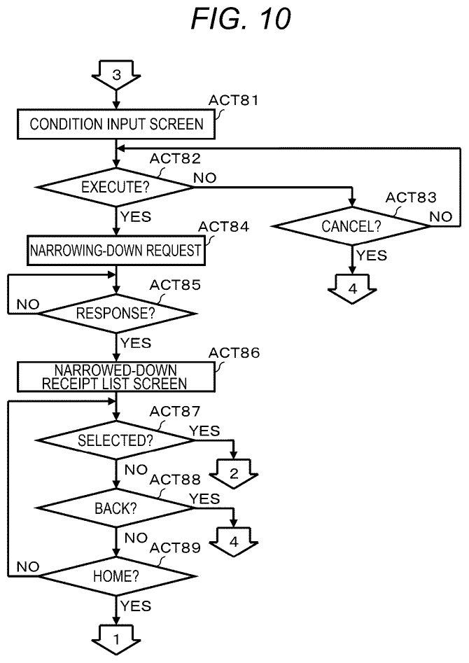

When the processor 31 detects input of the NARROW DOWN button BTg in the standby state in ACT13 through ACT16 in FIG. 6, the processor 31 proceeds to ACT81 in FIG. 10. As ACT81, the processor 31 sets a condition input screen SCh (see FIG. 21) on the screen of the touch panel 35.

FIG. 21 shows an example of an image displayed on the condition input screen SCh. As shown in the drawing, the condition input screen SCh is zoned into a title area TIg, a condition input area ARm, and an operation button area ARn. In the title area TIg, a cancel button BTs is disposed together with a title “NARROWING-DOWN CONDITION INPUT.” A pull-down menu box PDa for selecting a first narrowing-down condition, and a pull-down menu box PDb for selecting a second narrowing-down condition are disposed in the condition input area ARm. An EXECUTE button BTt for receiving an execution instruction for the narrowing down is disposed in the operation button area ARn.

In the present embodiment, the first narrowing-down condition is a store name. The second narrowing-down condition is the type of a receipt. When the pull-down menu box PDb for the second narrowing-down condition is selected, a pull-down list LSa from which the type of a receipt can be selected is displayed as shown in FIG. 22. The pull-down list LSa shows the types of receipts and radio buttons RBc, RBd, RBe, and RBf are arranged for the respective types. For example, it is sufficient for the electronic receipt member who needs to confirm purchase receipts issued in transactions that were corrected in the cash-register-minus mode to select the radio button RBe corresponding to “UNCORRECTED ORIGINAL RECEIPT” from the pull-down list LSa, and then tap the EXECUTE button BTt.

The processor 31 of the information terminal 30 then proceeds to ACT82. As ACT82, the processor 31 checks whether the EXECUTE button BTt was tapped. When the EXECUTE button BTt was not tapped, the processor 31 proceeds to ACT83. As ACT83, the processor 31 checks whether the cancel button BTs was tapped. When the cancel button BTs was not tapped, the processor 31 returns to ACT82.

As described above, the processor 31 of the information terminal 30 displays the condition input screen SCh and awaits a tap on the EXECUTE button BTt or a tap on the cancel button BTs in ACT82 and ACT83. In this standby state, when a tap on the cancel button BTs is detected, the processor 31 returns to ACT12 in FIG. 6. The processor 31 restores the receipt list screen SCc on the screen of the touch panel 35 from the condition input screen SCh.

When the processor 31 detects a tap on the EXECUTE button BTt in the standby state in ACT82 and ACT83, the processor 31 proceeds to ACT84. As ACT84, the processor 31 performs control for transmitting a narrowing-down request command to the receipt server 10. Due to this control, the narrowing-down request command is transmitted wirelessly from the wireless communication unit 33. The narrowing-down request command is transmitted to the receipt server 10 via the second communication network NWb. The electronic receipt ID set to the information terminal 30 is included in the narrowing-down request command. When the first narrowing-down condition is selected in the condition input area ARm, information corresponding to the first narrowing-down condition is included. When the second narrowing-down condition is selected in the condition input area ARm, information corresponding to the second narrowing-down condition is included.

The processor 11 of the receipt server 10 receives the narrowing-down request command and operates as the response unit 113. In other words, the processor 11 extracts the receipt record(s) 171 satisfying the first narrowing-down condition or the second narrowing-down condition out of all the receipt records 171 stored in the receipt file 17 in association with the electronic receipt ID included in the narrowing-down request command. Then, the processor 11 generates data of the narrowed-down receipt list image based on the receipt identification information of the receipt record 171 thus extracted. The processor 11 transmits the data of the narrowed-down receipt list image to the information terminal 30

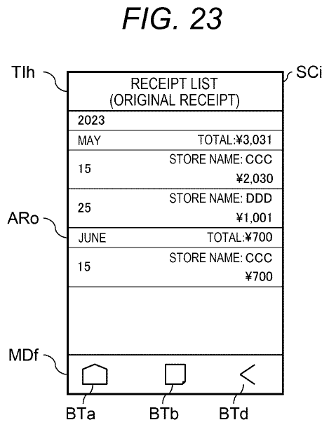

The processor 31 of the information terminal 30 which controlled the transmission of the narrowing-down request command proceeds to ACT85. As ACT85, the processor 31 awaits reception of the data of the narrowed-down receipt list image. When the processor 31 receives the data of the narrowed-down receipt list image via the wireless communication unit 33, the processor 31 proceeds to ACT86. As ACT86, the processor 31 sets a receipt list screen SCi (see FIG. 23) on the screen of the touch panel 35.

FIG. 23 shows an example of an image displayed in the narrowed-down receipt list screen SCi. The narrowed-down receipt list screen SCi corresponds to when the original receipt is selected as the second narrowing-down condition. As shown in the drawing, the narrowed-down receipt list screen SCi is zoned into a title area TIh, a receipt list area ARo, and a mode area MDf. In the title area TIh, a text representing the narrowing-down condition is displayed together with a title “RECEIPT LIST.”

The narrowed-down receipt list image is displayed in the receipt list area ARo. The narrowed-down receipt list image is an image in which the receipt identification information (the date, the store name, the settlement amount) of each of the electronic receipts narrowed down with the narrowing-down condition is arranged in the order of date.

In the mode area MDf, the home button BTa, the receipt button BTb, and the back button BTd are displayed similarly to the receipt list screen SCc. The input of the receipt button BTb is invalidated, which is also the same as in the receipt list screen SCc.

The processor 31 of the information terminal 30 which displays the narrowed-down receipt list screen SCi proceeds to ACT87. As ACT87, the processor 31 confirms whether the row in which the receipt identification information is displayed was selected. When the row in which the receipt identification information is displayed was not selected, the processor 31 proceeds to ACT88. As ACT88, the processor 31 confirms whether the back button BTd was tapped. When the back button BTd was not tapped, the processor 31 proceeds to ACT89. As ACT89, the processor 31 confirms whether the home button BTa was tapped. When the home button BTa was not tapped, the processor 31 returns to ACT87.

As described above, the processor 31 of the information terminal 30 which displays the narrowed-down receipt list screen SCi awaits selection of the row in which the receipt identification information is displayed, a tap on the back button BTd, or a tap on the home button BTa in ACT87 through ACT89. In this standby state, when a tap on the back button BTd is detected, the processor 31 returns to ACT12 in FIG. 6. In other words, the processor 31 restores the receipt list screen SCc on the screen of the touch panel 35 from the narrowed-down receipt list screen SCi. When a tap on the home button BTa is detected, the processor 31 returns to ACT1 in FIG. 6. In other words, the processor 31 restores the home screen SCa on the screen of the touch panel 35 from the narrowed-down receipt list screen SCi.

When the processor 31 detects the selection of the row in which the receipt identification information is displayed in the standby state in ACT87 through ACT89, the processor 31 proceeds to ACT21 in FIG. 7. As ACT21, the processor 31 performs control of transmitting a receipt request command to the receipt server 10. Thereafter, the processor 31 executes the processing in and after ACT21 in substantially the same manner as described above.

### Additional Description of Electronic Receipt System Operation

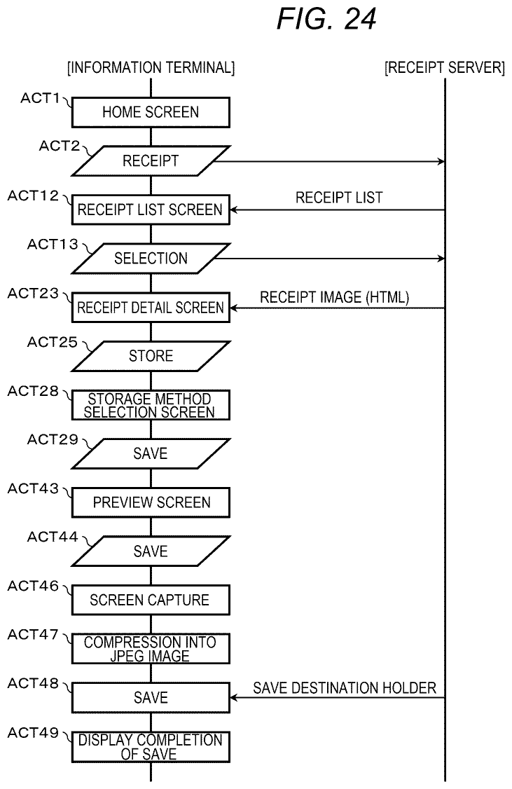

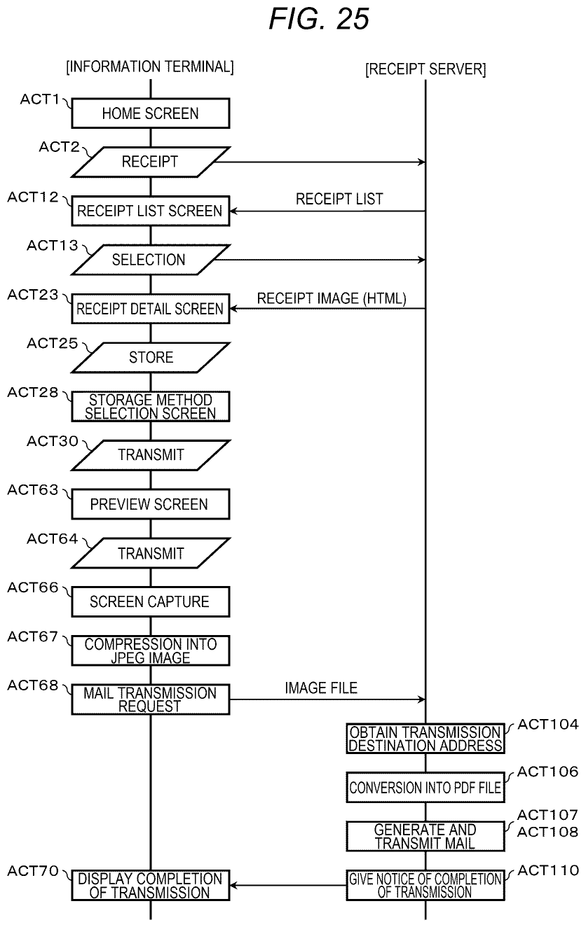

FIG. 24 is a processing sequence diagram for the information terminal 30 and the receipt server 10 when processing for saving an image file in the storage unit is instructed. FIG. 25 is a processing sequence diagram for the information terminal 30 and the receipt server 10 when processing for transmitting an e-mail with an image file attached to a predetermined mail address is instructed. It should be noted that processing acts corresponding to those in flowcharts shown in FIG. 6 through FIG. 11 use the same reference symbols in these subsequent figures.

First, an operation performed when the processing for saving an image file in the storage unit for the information terminal 30 is instructed as the processing related to the storage of the receipt image will be described using FIG. 24.

As shown in FIG. 24, when the electronic receipt member taps (ACT1, ACT2) the receipt button BTb in the home screen SCa displayed on the touch panel 35 of the information terminal 30, the transition from the home screen SCa to the receipt list screen SCc is made (ACT12) by an operation of the receipt server 10. Here, when the electronic receipt member selects (ACT13) the receipt identification information of a receipt which the member wants to save as an image file, the receipt server 10 generates image data in, for example, the HTML format for the receipt identified by the receipt identification information, and then transmits the generated image data to the information terminal 30. Then, the receipt detail screen SCd is displayed (ACT23) on the touch panel 35 of the information terminal 30.

The STORE button BTh is displayed in the receipt detail screen SCd together with the image of the receipt which needs to be saved as the image file, and the electronic receipt member taps (ACT25) the STORE button BTh. Then, the storage method selection screen SCe is displayed (ACT28) on the touch panel 35, and the electronic receipt member taps (ACT29) the SAVE button BTj. Then, the preview screen SCf is displayed (ACT43) on the touch panel 35, and the electronic receipt member taps (ACT44) the SAVE button BTn.

When the electronic receipt member performs the operation described above, the image of the receipt displayed in the preview area ARh is captured (ACT46) in the information terminal 30. The image thus captured is converted (ACT47) into an image file in, for example, the JPEG format. Then, the image file is saved (ACT48) in the storage unit specified by the information of the save destination folder managed by the receipt server 10.

When the image file is saved, the pop-up image PUa representing the save completion is displayed (ACT49) on the touch panel 35 of the information terminal 30. Therefore, the electronic receipt member can be aware that the image file of the receipt image was saved in the desired save destination folder.

Then, the operation performed when the processing for transmitting an e-mail with the image file to a predetermined mail address is instructed will be described using FIG. 25. It should be noted that the processing from when the electronic receipt member taps the receipt button BTb of the home screen SCa to when the member taps the STORE button BTh of the receipt detail screen SCd (ACT1 through ACT25) is substantially the same as the processing when the processing for saving the image file in the storage unit provided to the information terminal 30 is instructed, and therefore, the description thereof will be omitted here.

As shown in FIG. 25, when the storage method selection screen SCe is displayed on the touch panel 35 of the information terminal 30 in response to tapping of the STORE button BTh, the electronic receipt member taps (ACT30) the TRANSMIT button BTk. Then, the preview screen SCg is displayed (ACT63) on the touch panel 35, and the electronic receipt member taps (ACT64) the TRANSMIT button BTq.

When the electronic receipt member performs the operation described above, the image of the receipt displayed in the preview area ARj is captured (ACT66) in the information terminal 30. The image thus captured is converted (ACT67) into an image file in, for example, the JPEG format. Then, the image file is included in the mail transmission request command, and is transmitted (ACT68) to the receipt server 10.

In the receipt server 10, the mail transmission destination address set in advance is obtained (ACT104) from the member file 18. The image file is converted (ACT104) into an image file in PDF. Then, an e-mail with the image file in PDF is generated, and is transmitted to the mail transmission destination address.

When the transmission of the e-mail is completed, receipt server 10 issues (ACT110) the transmission completion notice to the information terminal 30. In response to this notice, the pop-up image PUb representing the transmission completion is displayed (ACT70) on the touch panel 35 of the information terminal 30. Therefore, the electronic receipt member can be aware of the fact that the e-mail with the image file of the receipt image was transmitted to the desired transmission destination address.

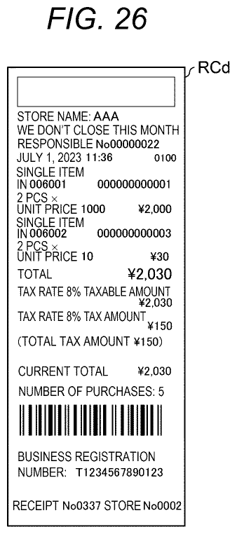

FIG. 26 shows an example of issuance of a receipt RCd which can be used as an eligible invoice. According to the present embodiment, it is possible to store the image of such a receipt RCd in the storage unit designated by the information terminal 30 as an image file compressed in, for example, the JPEG format. Alternatively, it is possible to store the image of the receipt RCd by transmitting an e-mail with an image file obtained by converting the image into, for example, PDF to the designated computer device 50.

In the present embodiment, just by operating the instruction part displayed in one screen of the receipt detail screen SCd together with the receipt image, it is possible to save or e-mail the image file of the receipt image. Therefore, there is an advantage that it is possible for everyone to easily store the image file without performing an operation for a screenshot on the information terminal 30.

In the present embodiment, “UNCORRECTED ORIGINAL RECEIPT” can be added as an alternative of the narrowing-down conditions which can be selected in the condition input screen SCh. By setting this alternative “UNCORRECTED ORIGINAL RECEIPT” as the narrowing-down condition, it is possible for the electronic receipt member to obtain an image of a purchase receipt which was issued in the transaction as the origin of the transaction corrected in the cash-register-minus mode.

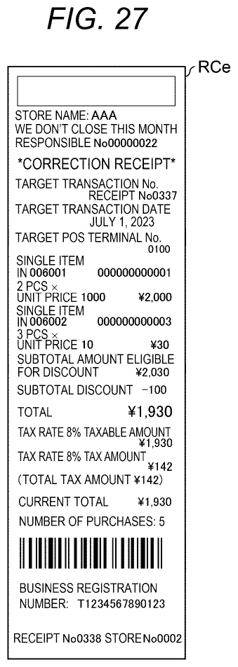

For example, a sales clerk declares cash-register-minus on the POS terminal 20 with respect to the transaction in which the receipt RCd shown in FIG. 26 is issued since the sales clerk forgot to cut the price by 100 yen, and then, reads the barcode on the original receipt RCd. Then, the data of the transaction identified by that barcode is read out from a journal file, and the sales clerk performs an operation of cutting the price by 100 yen. Then, a new receipt RCe with a description of CORRECTION RECEIPT as shown in FIG. 27 is issued.

The receipt identification information of the new receipt RCe is displayed in the receipt list screen SCc. Therefore, it is possible for the electronic receipt member to store the image file obtained by changing the image of the new receipt RCe into an electronic file. However, the receipt identification information of the original receipt RCd is not displayed in the receipt list screen SCc. Therefore, the electronic receipt member who needs to store the image file obtained by changing the image of the original receipt RCd into an electronic file selects “UNCORRECTED ORIGINAL RECEIPT” as the alternative of the narrowing-down conditions. Then, the receipt identification information of the original receipt RCd is displayed in the narrowed-down receipt list screen SCi. Therefore, it is possible for the electronic receipt member to store also the image file obtained by changing the image of the original receipt RCd into an electronic file with a simple operation.

### Other Embodiments

In the example embodiment described above, it is possible to select the storage method by first processing (the method of saving an image in the storage unit of the information terminal 30) or second processing (the method of saving an image by e-mailing the image to an external computer device 50). As another embodiment, it is possible to execute just one of the storage methods without option or the like.

For example, when the STORE button BTh disposed in the receipt detail screen SCd is tapped, the transition to the preview screen SCf shown in FIG. 17 is made when just the storage method based on the first processing can be executed, or the transition to the preview screen SCg shown in FIG. 19 is made when just the storage method based on the second processing can be executed.

In an embodiment described above, the information of the save destination folder and the information of the mail transmission destination address are stored for each of the electronic receipt members in the member file 18. As another embodiment, the information of the save destination folder and the information of the mail transmission destination address of each of the electronic receipt members may instead be stored in the information terminal 30 of each respective electronic receipt member. Alternatively, only the information of the save destination folder may be stored in the information terminal 30 and the information of the mail transmission destination address can be stored in the member file 18, or vice versa.

In an embodiment described above, the receipt server 10 is provided with the mailer (mail program) and transmits the e-mail with the image file to the mail transmission destination address. The device which transmits the e-mail is not limited to the receipt server 10. For example, a mail server may be incorporated into the receipt center 1, and the mail server may transmit the instead of server e-mail the receipt 10. Alternatively, it is also possible for the information terminal 30 to transmit the e-mail with the image file using a mail transmission function provided by the information terminal 30 itself.

In an embodiment described above, just one mail transmission destination address is set for each of the electronic receipt members, but it is possible to set two or more mail transmission destination addresses and to transmit the e-mail with the image file of the receipt to two or more computer devices 50.

In an embodiment described above, an image file obtained by compressing the data of the receipt image in the JPEG format is generated in the information terminal 30, but the format of the image file is not limited to the JPEG format. It is also possible to use a file format such as GIF, PING, or TIFF.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. An information processing terminal, comprising:
a storage unit;
a communication interface configured to connect to a receipt server storing receipt data in electronic format in association with buyer identification information; and
a control unit configured to:
cause a receipt image corresponding to the receipt data received from the receipt server to be displayed on a display device along with an instruction input part for receiving a user selection of an option for storage of data corresponding to the receipt image;
create an electronic image file corresponding to the receipt image displayed on the display device;
receive the user selection of the option for the storage of the data corresponding to the receipt image via the instruction input part; and
cause the electronic image file to be stored in the storage unit or sent via e-mail to a user-designated e-mail address.

2. The information processing terminal according to claim 1, wherein the electronic image file is created as a screen capture.

3. The information processing terminal according to claim 1, wherein the electronic image file is created as JPEG file.

4. The information processing terminal according to claim 3, wherein the electronic image file is converted to a PDF before being sent via the e-mail.

5. The information processing terminal according to claim 4, wherein the receipt data is received as html data.

6. The information processing terminal according to claim 1, wherein the control unit causes the electronic image file to be sent via the email by using a mail program of the information processing terminal.

7. The information processing terminal according to claim 1, wherein the control unit causes the electronic image file to be sent via the email by sending the electronic image file and an email request to the receipt server.

8. The information processing terminal according to claim 1, wherein the electronic image file is converted to a PDF before being sent via the e-mail.

9. The information processing terminal according to claim 1, wherein the receipt data is received as html data.

10. A method for receipt management using an information processing terminal, the method comprising:
causing a receipt image corresponding to receipt data received from an electronic receipt server to be displayed on a display device along with an instruction input part for receiving a user selection of an option for storage of data corresponding to the receipt image;
creating an electronic image file corresponding to the receipt image displayed on the display device;
receiving the user selection of the option for the storage of the data corresponding to the receipt image via the instruction input part; and
causing the electronic image file to be stored in a storage unit or sent via e-mail to a user-designated e-mail address.

11. The method according to claim 10, wherein the electronic image file is created as a screen capture.

12. The method according to claim 10, wherein the electronic image file is created as JPEG file.

13. The method according to claim 10, wherein the electronic image file is converted to a PDF before being sent via the e-mail.

14. The method according to claim 10, wherein the receipt data is received as html data.

15. The method according to claim 10, wherein the email is sent by using a mail program of the information processing terminal.

16. The method according to claim 10, wherein the email is caused to be sent by sending the electronic image file and an email request to the electronic receipt server.

17. An electronic receipt system, comprising:
a receipt server which is configured to store receipt data in electronic format in association with buyer identification information;
an information processing terminal including:
a storage unit;
a communication interface configured to connect to the receipt server; and
a control unit configured to:
cause a receipt image corresponding to the receipt data received from the receipt server to be displayed on a display device along with an instruction input part for receiving a user selection of an option for storage of data corresponding to the receipt image;
create an electronic image file corresponding to the receipt image displayed on the display device;
receive the user selection of the option for the storage of the data corresponding to the receipt image via the instruction input part; and
cause the electronic image file to be stored in the storage unit or sent via e-mail to a user-designated e-mail address.

18. The electronic receipt system according to claim 17, wherein the electronic image file is created as a screen capture.

19. The electronic receipt system according to claim 17, wherein the control unit causes the electronic image file to be sent via the email by using a mail program of the information processing terminal.

20. The electronic receipt system according to claim 17, wherein the control unit causes the electronic image file to be sent via the email by sending the electronic image file and an email request to the receipt server.
